(19) United States
(12) Patent Application Publication
(10) Pub. No.: US 2025/0013510 A1
(43) Pub. Date: Jan. 9, 2025

(54) TECHNIQUES FOR MITIGATING BACK PRESSURE, AUTO-SCALING THROUGHPUT, AND CONCURRENCY SCALING IN LARGE-SCALE AUTOMATED EVENT-DRIVEN DATA PIPELINES

(71) Applicant: EQUIFAX INC., Atlanta, GA (US)

(72) Inventor: Michael SMITH, Nampa, ID (US)

(21) Appl. No.: 18/348,970

(22) Filed: Jul. 7, 2023

(51) Int. Cl. G06F 9/54

(52) U.S. Cl. CPC G06F 9/542; G06F 9/546

(57) ABSTRACT

Systems and methods for fine-tuned control over data transfer processes. An exemplary data transfer process may include: receiving a data stream at a storage service; receiving, at a first function, one or more notifications; in response to each notification, passing, by the first function, a message to a queue, the message comprising an address of a respective file within the storage service; receiving, at an invocation of a second function at a second computing service, one or more messages from the queue; retrieving, by the second function, data from one or more files based on the address in each of the one or more messages; and writing, by the second function, the data to a database. Systems and methods according to aspects of the present disclosure improve processes of transferring data from a data warehouse or database to a cloud-based database by mitigating back-pressure, auto-scaling throughput, and controlling concurrency scaling.

### TECHNICAL FIELD

The present disclosure relates generally to data-transfer techniques, and more particularly, although not exclusively, to techniques for providing fine-tuned control over data transfer processes.

### BACKGROUND

Large-scale data transfer may be required to enable external applications or processes to access data from a cloud-based database via an application programming interface (API). For example, large amounts of data (e.g., Terabytes of data) may need to be transferred from a data warehouse or database to a cloud-based database so the data may be consumed by the external application or process. However, concurrency limitations and throttling can render large-scale data transfer infeasible.

Concurrency limitations and throttling can slow or stop the data-transfer process and may require human intervention. Thus, there is a need for systems and methods to transfer large amounts of data automatically and to mitigate inefficiencies traditionally associated with large-scale data transfer.

### BRIEF SUMMARY

Various aspects of the present disclosure provide systems and methods for improving large-scale data transfer processes. According to one example, a system can include a processor and a memory, such as a non-transitory computer-readable medium, which includes instructions that are executable by the processor to cause the processor to perform various operations. According to aspects of the current disclosure, the operations can include receiving, from a data warehouse, a data stream at a storage service. The operations can include receiving, at a first function of a first computing service, one or more notifications, where each notification is generated when a file containing data from the data stream is created in the storage service. The operations can also include, in response to each notification, passing, by the first function, a message to a queue, the message including an address of a respective file within the storage service and a message group ID selected from a range. The operations can further include receiving, at an invocation of a plurality of invocations of a second function at a second computing service, one or more messages from the queue, wherein the invocation of the second function to which each message is routed is based on the message group ID. The operations can also include retrieving, by the second function, data from one or more files based on the address in each of the one or more messages. The operations may additionally include writing, by the second function, the data to a database.

According to an additional example of the present disclosure, a method of improving large-scale data transfer is provided. The method may include, receiving, from a data warehouse, a data stream at a storage service. The method can include receiving, at a first function of a first computing service, one or more notifications, where each notification is generated when a file containing data from the data stream is created in the storage service. The method can also include, in response to each notification, passing, by the first function, a message to a queue, the message including an address of a respective file within the storage service and a message group ID selected from a range. The method can further include receiving, at an invocation of a plurality of invocations of a second function at a second computing service, one or more messages from the queue, wherein a number of routines within the invocation of the second function is based on the message group ID. The method can also include retrieving, by the second function, data from one or more files based on the address in each of the one or more messages. The method may additionally include writing, by the second function, the data to a database.

According to another example of the present disclosure, a non-transitory computer-readable medium may contain instructions that are executable by a processor to cause the processor to perform operations. According to aspects of the current disclosure, the operations can include receiving, from a data warehouse, a data stream at a storage service. The operations can include receiving, at a first function of a first computing service, one or more notifications, where each notification is generated when a file containing data from the data stream is created in the storage service. The operations can also include, in response to each notification, passing, by the first function, a message to the queue, the message including an address of a respective file within the storage service and a message group ID selected from a range. The operations can further include receiving, at an invocation of a plurality of invocations of a second function at a second computing service, one or more messages from the queue, where the invocation of the second function to which each message is routed is based on the message group ID. The operations can also include retrieving, by the second function, data from one or more files based on the address in each of the one or more messages. The operations may additionally include writing, by the second function, the data to a database.

### BRIEF DESCRIPTION OF THE DRAWINGS

FIG. 1 is a block diagram depicting an example of a system for large-scale data transfer.

FIG. 2 is a block diagram depicting a computing system suitable for implementing certain aspects of the present disclosure.

FIG. 3 is a flow chart depicting an example of a process for large-scale data transfer.

### DETAILED DESCRIPTION

Certain aspects of the present disclosure are directed to techniques for mitigating back-pressure, autoscaling throughput, and concurrency scaling in large-scale automated event-driven data pipelines. For example, techniques according to aspects of the present disclosure may result in automated large-scale data transfer from a data warehouse to a cloud-based database.

Currently, systems of large-scale data transfer suffer from throttling and write capacity limits. In some cloud-based systems, throttling may be adjusted by requesting additional bandwidth or resources, at an additional cost, from the cloud service provider. However, this results in additional cost and time for the user. For example, a user may run a data transfer process that fails due to capacity limits or may run a data transfer process that takes an extended amount of time to complete. The disclosed examples obviate the need to request additional bandwidth by enabling a user to tune the concurrency of writes to the cloud-based database such that the data transferred remains under the throttling limit and the transfer capacity is maximized.

Current systems for large-scale data transfer may suffer from back-pressure when, for example, an event producer (e.g., event-driven storage service) generates messages for a queue faster than a function can process the handling. In other examples, current systems require manual changes to an autoscaling policy to adjust capacity based on workload. If a process is handling read/write operations beyond a provisioned capacity, the process may be throttled. Additionally, a service may limit the number of in-flight requests a function may handle at a time, e.g., the concurrency. An increase in concurrency of a function can often not be performed dynamically and requires a request for an increase from the service provider.

In an example of the present disclosure, data may be transferred from a data warehouse to a cloud-based database. For example, data stored in a physical database may need to be moved to the cloud-based database for consumption by an external application. The database may be hosted on a cloud platform by a cloud service provider, e.g., Amazon Web Services (AWS). Managed services may be hosted on the cloud platform and may include one or more additional components such as a computing service designed to execute serverless functions, a storage service, and a queueing service.

In an example of the present disclosure, a service may require data transfer from a data warehouse to a cloud-based database to make that data available to external consumers (e.g., external applications or processes). The service may trigger a data transfer process which may be initiated manually, or at predetermined intervals. In some examples, a serverless function may manage and trigger the service requiring the data transfer process. In other examples, each of a number of functions may manage a separate service, where the services require a data transfer process to be initiated at varying intervals. For example, one service may require cloud-availability of data from the data warehouse on a weekly basis, while another service may require data to be transferred on a daily basis. In yet another example, a user, via a client device, may manually trigger a data transfer process.

Once the service is initiated, it may trigger a data transfer process in which data from the data warehouse is uploaded into a cloud-based storage system. The storage system may be event-driven and may generate event notifications, for example, each time a new object is created. These event notifications may be used to trigger a first function to pass one or more messages to a queue. Each message may include a pointer to where data from the data warehouse is stored in the cloud-based storage system. For example, a message may indicate that a file was created in a particular bucket with a particular path within that bucket. In some examples, this or similar address information may be contained in the event notification, such that the event notification may be handled as a message.

Each message may further include a message group ID. The message group ID may be an integer value randomly selected by a random number generator from a predetermined range. The predetermined range may be set by a user via a client device. The threshold value may correspond to the number of invocations of the second function that may pull or receive data from the storage service simultaneously. The range of possible values may be manually set by a user via a client device and may correspond to the number of invocations of a second function that receive messages from the queue. Accordingly, there is one invocation of the second function per message group ID.

The message queue may be managed by a queueing service. The first function may receive a notification and may direct that notification (or a message containing address information) to the queue. The queue managed by the queueing service may be a first-in-first-out (FIFO) queue and may be configured to handle message groups.

The second function, which is decoupled from the first function, may receive the messages in each queue and retrieve data from the storage system based on the address information contained in each message. For example, a message may be routed to a particular invocation of the second function based on message group ID and that invocation of the second function may retrieve the data pointed to in the message. Subsequently, the second function can write this data to the cloud-based database.

Further, a user may additionally control the number of routines of each invocation of the second function that may simultaneously write to the database. For example, when each row of data being transferred is larger than a given threshold, i.e., it takes longer to write to the database, the number of routines may be increased. By increasing the threshold, more routines within an invocation may simultaneously write to the database, thereby avoiding the need to use additional functions, which can result in processing delays and additional cost.

Accordingly, examples of the present disclosure provide fine-tuned control over concurrency of invocations and routines of the second function. For example, a user may adjust both the number of invocations of the second function and the number of routines within each invocation of the second function that are allowed to write to the cloud-based database. Controlling the concurrency of the invocations and routines of the second function enables the system to mitigate the threat of throttling from the cloud-based database and the threat of reaching a write capacity threshold of the cloud-based database.

According to examples of the present disclosure, the described architecture enables automated data transfer capable of dynamically complying with capacity and throughput system requirements without human intervention. Large-scale data transfer may be required, for example, to support one or more services, where each service may run at a different interval (e.g., hourly, daily, weekly, etc.). Accordingly, there is a need for a large-scale data transfer process that provides automation capability, manual capability, monitoring, and maintainability, and that completes quickly, handles many large records, and is self-contained. The examples provided in the present disclosure provide the above advantages over conventional data-transfer systems. For example, disclosed systems may run on an automated schedule or may be manually triggered. Disclosed systems facilitate monitoring such that an on-call team member may be alerted if a process fails. Further, disclosed example architectures may be easily modified by developers (e.g., the processes are robust).

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

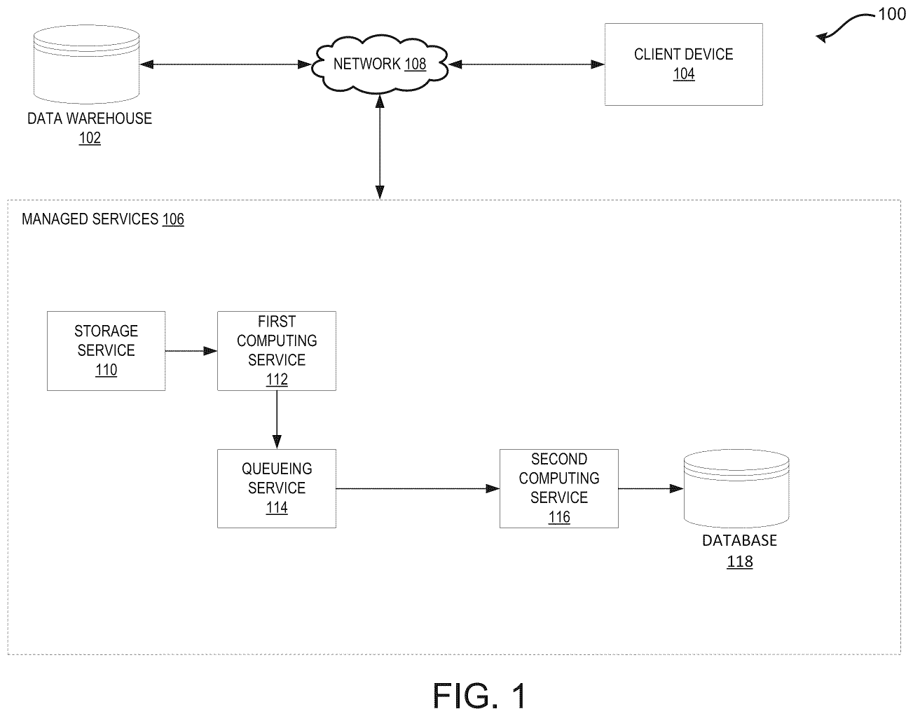

Referring now to the drawings, FIG. 1 is a block diagram depicting an example of a system 100 for implementing large-scale data transfer. System 100 may include a data warehouse 102, a client device 104, and managed services 106, which communicate via a network 108.

Data warehouse 102 may be one or more databases capable of storing data from one or more sources. The data warehouse 102 may include an extract, transform, load (ETL)-based data warehouse. In some examples, the data warehouse 102 may store data (e.g., customer data) to be consumed or used by one or more services. The one or more services may access the data from a cloud-based database (e.g., database 118) via an application programming interface (API). Accordingly, processes described herein enable transfer of the data from the data warehouse 102 to the database 118 for use by the one or more services. As such, disclosed processes are robust and efficient, thereby enabling the one or more services to run on an automated basis, with minimal manual intervention.

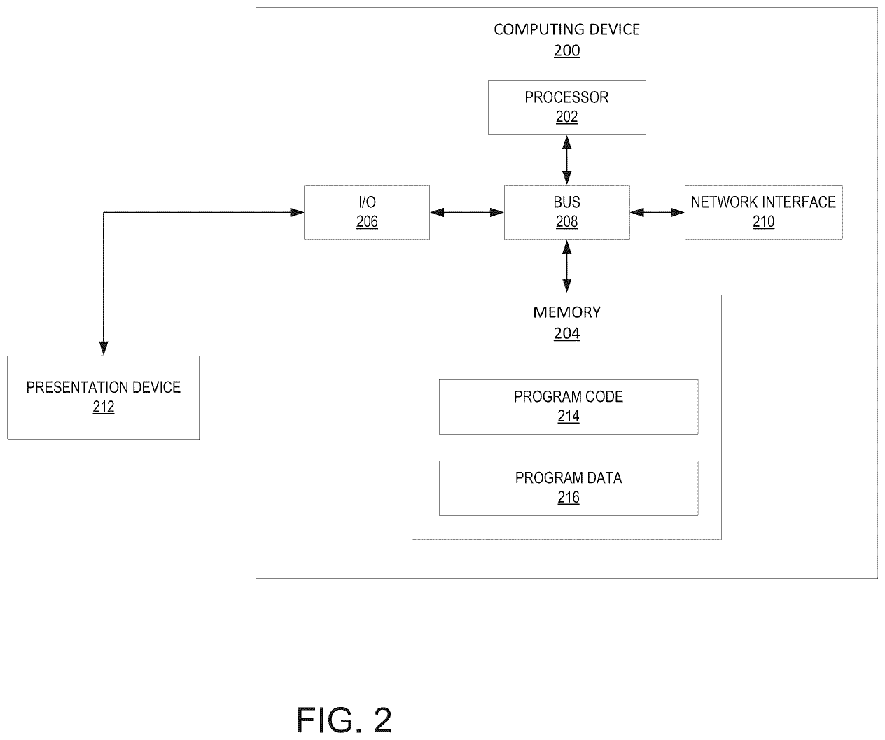

The client device 104 may be a computing or processing device that can access the data warehouse 102 and the managed services 106. For example, the client device 104 may be a personal computing device or other device configured to execute program code to perform the operations described herein. The client device 104 will be discussed further with reference to FIG. 2, below. In some examples, the client device 104 may receive and to store one or more parameters associated with the data transfer process. For example, a parameter may be the number of concurrent or simultaneous invocations of a second function of the second computing service 116 that receive messages from the queue managed by the queueing service 114. Another parameter may be the number of routines within an invocation of the second function of second computing service 116 that are allowed to write to the cloud-based database (e.g., database 118).

The managed services 106 may be hosted by a cloud computing system capable of performing distributed computing and storage functions, or a combination thereof. For example, the managed services 106 may be hosted on a system such as Amazon Web Services, which may host cloud-based storage and FaaS offerings. In examples of the present disclosure, the managed services 106 may include a block storage service (e.g., storage service 110), one or more computing services hosting FaaS offerings (e.g., first computing service 112 and second computing service 116), a queueing service (e.g., queueing service 114), and the database (e.g., database 118), or a combination thereof. These components may be hosted by a single cloud platform, or, in other examples, may be hosted on a number of separate cloud platforms.

The client device 104 may communicate with one or more components of the managed services 106 via network 108. For example, a user may input or modify one or more parameters associated with components of the managed services 106 via client device 104. Thus, a user may tune properties (e.g., the number of concurrent invocations and number of routines per invocation) of the second function of the second computing system 116 to mitigate throttling of the data transfer process and write capacity of database 118.

The storage service 110 may be a block storage system of the cloud-based system hosting the managed services 106. For example, the storage service 110 may be a simple storage solution such as Amazon S3. The storage service 110 may receive data uploaded from the data warehouse 102. The storage service 110 may be event-driven, i.e., storage service 110 may generate event notifications when, for example, a new object is created. These event notifications may be used to trigger downstream processes/functions (e.g., first function of first computing service 112). For example, an event notification may be used as a trigger to kick off a function to generate a message queue at the queueing service 114. In some examples, the contents of the event notification may indicate an address within the storage service 110 at which a file containing certain data is stored. This information may be included in the generated messages along with a randomly assigned message group ID. For example, the message may contain a pointer that points to a particular location within the storage service 110 at which certain data is stored after being received from the data warehouse 102.

The first computing service 112 and the second computing service 116 may be serverless computing services (e.g., AWS Lambda) of a cloud system. In some examples, the computing services may enable execution of code uploaded to the computing services from the client device 104. The computing services may automatically scale to handle requests to execute the uploaded code. The computing services may support serverless functions that are triggered by events. For example, a first function of the first computing service 112 may be triggered by event notifications generated as data is uploaded to the storage service 110. For example, an event notification may be triggered in response to a file being created in the storage service 110 to store data received from the data warehouse 102. The first and second functions of the first computing service 112 and the second computing service 116 may be instantiated and provisioned on physical or virtual resources, or a combination thereof.

In some examples of the present disclosure, the first function of the first computing service 112 may generate messages in response to event notifications from the storage service 110. Each message may be associated with a message group ID randomly selected from a range of integer values. For example, a range may be values from zero to n or 1 to n where n is an integer value equal to the number of concurrent invocations of the second function that receive messages from the queue managed by the queueing service 114. A user may set the value for n via client device 104. In some examples, the range of message group IDs assigned by the first function may be dependent upon which service initiates the data transfer process. A service requiring a larger amount of data to be transferred may be associated with a higher number of invocations of the second function than a service requiring a smaller amount of data to be transferred.

The queueing service 114 may be a queueing service such as AWS Simple Queue Service (SQS). The queueing service 114 may be configured as a FIFO queue.

The queueing service 114 may send, store, and receive messages between components of the managed services 106 (e.g., between the first computing service 112 and the second computing service 116). The messages handled by the FIFO queue may contain location information associated with data stored in the storage service 110 that is to be transferred from the data warehouse 102 to the database 118, and each of the messages may be associated with the message group ID assigned by the first function.

A second function of the second computing service 116 may receive messages from the FIFO queue handled by the queueing service 114, retrieve data from the locations in the storage service 110 indicated by the address information in the messages, and write the retrieved data to the database 118. In some examples, a user may set a parameter m as an integer value that is the number of workers, or routines, within an invocation of the second function that are allowed to simultaneously write to the database 118. The value for m may be input or modified by a user via client device 104. For example, a value of one would correlate to one routine within each invocation of the second function that writes the data to the database 118. In another example, the range of message group IDs may be one through five and the value of m may be three. In this example, there may be five invocations of the second function, each invocation having three routines simultaneously writing data to the database 118.

In some aspects of the present disclosure, the number of concurrent invocations may be used to drive the speed of writes to the database. For example, the number of invocations of the second function may correlate to a number of files to be transferred to the database with each routine within an invocation handling a subset of the file.

In examples of the present disclosure, the cloud-based system hosting the managed services 106 may also include the database 118. The database 118 may be a low-latency database (e.g., AWS DynamoDB). For example, the database 118 may be capable of handling a number of transactions per second (e.g., one or more million transactions) on a single cloud server. The database 118 may be hosted by the cloud-based system hosting the managed services 106, or may be hosted on a separate cloud platform. In some examples, the data may be temporarily stored by the storage service 110. For example, the data may be deleted from the storage service 110 once it is successfully transferred to the database 118.

The networks used for communication of the components of system 100 of FIG. 1 may be different types of data networks, such as a public data network, a private data network, or some combination thereof. A data network may include one or more of a variety of network types, including a wireless network, a wired network, or a combination of a wired and wireless network. Examples of suitable networks include, without limitation, the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices or components in the data network. In some examples, a network may be a virtual private network (VPN).

The number of components depicted in FIG. 1 is for illustrative purposes only. Different numbers and types of components may be used. For example, while certain components and subcomponents are shown as single components or subcomponents in FIG. 1, multiple components or subcomponents may be used instead. Similarly, it may be possible for components or subcomponents that are shown to be separate, such as for example, the storage service, the computing services, the queueing service and the database, may be instead implemented, alone or in combination, in a signal component or subcomponent.

Any suitable computing system or group of computing systems can serve as and perform the operations of the client device 104 described herein. In this regard, FIG. 2 is a block diagram depicting one example of a computing device 200, which can serve as the client device 104, and can be used to trigger a data transfer process and to set one or more parameters of the data transfer process, as described above. For example, the computing device 200 may be used to kick off a data transfer process manually or may be used to set an interval at which the data transfer process will run, according to aspects of the present disclosure. The computing device 200 may be used to modify one or more parameters associated with the data transfer process such as the number of concurrent invocations of the second function that receive messages from the queue or the number of routines of each invocation of the second function that may write to the database.

The computing device 200 can include various devices for communicating with other devices in system 100, as described with respect to FIG. 1. As shown in FIG. 2, the computing device 200 can include a processor 202 that is communicatively coupled to a memory 204. The processor 202 can execute computer-executable program code stored in the memory 204, can access information stored in the memory 204, or both. The memory 204 can store program code in the form of instructions that, when executed by the processor 202, causes the processor 202 to perform the operations described herein. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc., may be passed, forwarded, or transmitted via any suitable means including memory sharing, message passing, token passing, network transmission, among others.

Examples of a processor 202 can include a microprocessor, an application-specific integrated circuit (ASIC), a field-programmable gate array (FPGA), or any other suitable processing device. The processor 202 can include any suitable number of processing devices, including one. In addition to communicating with the memory 204, the processor 202 can include a memory.

The memory 204 can include any suitable non-transitory computer-readable medium. The computer-readable medium can include any electronic, optical, magnetic, or other storage device capable of providing a processor with computer-readable program code or other program code. Non-limiting examples of a computer-readable medium can include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language can include Hadoop, C, C++, C#, Visual Basic, Java, Python, Perl, JavaScript, ActionScript, etc.

The computing device 200 may also include a number of external or internal devices such as input or output devices. For example, the computing device 200 is illustrated with an input/output (I/O) interface 206 that can receive input from input devices or provide output to output devices. A bus 208 can also be included in the computing device 200. The bus 208 can communicatively couple one or more components of the computing device 200.

In some examples, the computing device 200 can include one or more output devices. One example of such an output device may be the network interface device 210. A network interface device 210 can include any device or group of devices suitable for establishing a wired or wireless data connection to one or more data networks, such as but not limited to, the network 108 depicted in FIG. 1. Non-limiting examples of the network interface device 210 can include an Ethernet network adapter, a modem, etc.

Another example of an output device can include a presentation device, such as the presentation device 212 depicted in FIG. 2. A presentation device 212 can include any device or group of devices suitable for providing visual, auditory, or other suitable sensory output. Non-limiting examples of the presentation device 212 can include a touchscreen, a monitor, a speaker, a separate mobile computing device, etc. Presentation device 212 may display one or more graphical user interfaces (GUIs) that may receive input from a user where the input includes values for the interval at which the data transfer process will run, the number of invocations of the second function that receive messages from the queue (e.g., where the number of invocations is equal to the maximum value of the range of message group IDs), and the number of routines within each invocation of the second function that can write to the database.

As further represented in FIG. 2, the computing device 200 can execute program code 214 that includes instructions to cause the processor 202 of the computing device 200 to perform the various operations described herein. For example, the instructions in the program code 214 may cause the processor to: initiate a data transfer process, upload function code to the computing services, and modify the parameters associated with the data transfer process.

The program code 214 may be resident in any suitable computer-readable medium, such as a non-transitory computer readable medium, and may be executed on any suitable processing device. For example, as depicted in FIG. 2, the program code 214 for performing the various operations described herein can reside in the memory 204 of the computing device 200 along with program data 216 associated with the program code 214. Initiating and configuring a large-scale data transfer process on the computing device 200 can configure the processor 202 to perform the operations described herein.

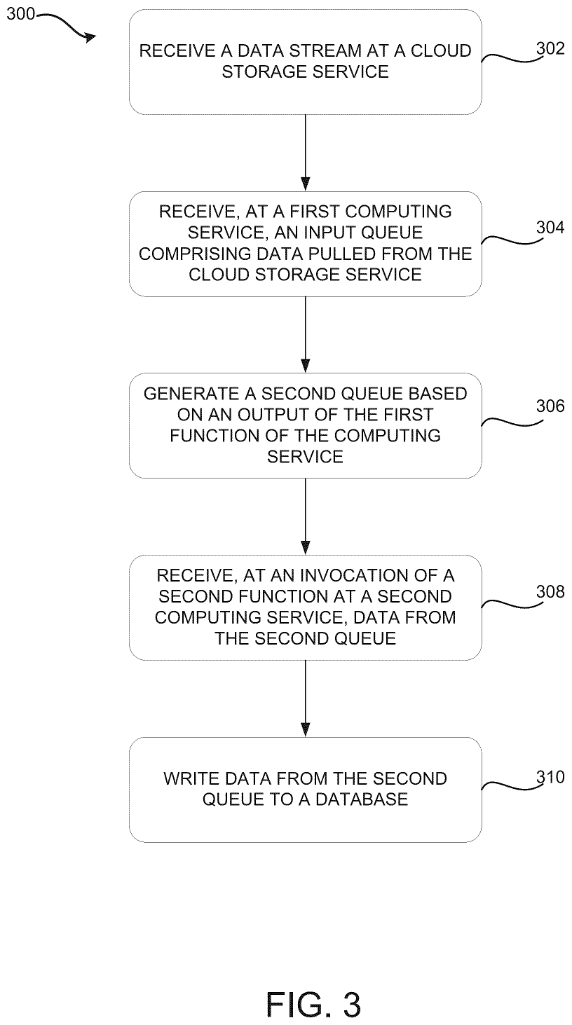

One example of a method of implementing automated large-scale data transfer is illustrated as a flow chart in FIG. 3. This example method can include, as depicted at block 300, receiving, from a data warehouse, a data stream at a storage service. For example, as discussed above, a service running at a given interval may initiate a data transfer process, which triggers the upload of data from a data warehouse (e.g., the data warehouse 102) to a storage service (e.g., the storage service 110 of the managed services 106). In some examples, data may be uploaded to the storage service as CSV files. The storage service may be an event-driven object storage system and may generate event notification upon completion of various events (e.g., upon creation of an object in storage, such as a file containing data from the data warehouse). In an example, the notification may indicate the creation of a file and may include the address of that file within the storage service. For example, address information may indicate that a file was created in a bucket of the storage service with a particular path to the file within the bucket.

As depicted at block 304, a first computing service may receive one or more notifications. Each notification may be generated when a file containing data from the data warehouse is created in the storage service. As described above, the notification may include address or location information, such as a pointer, that may be used to access the stored data in the storage service.

As depicted at block, 306, in response to each notification, the first computing service ma pass a message to a queue. Messages may be generated based on the received notifications. For example, a message may contain the address information provided by the notification. In some examples, each message may be assigned, by the first computing service, a message group ID. The message group ID may be assigned randomly and may be selected from a range of integers. For example, a first function of the first computing service (e.g., the first computing service 112) may be programmed to generate the messages and to assign each message a message group ID. The range of message group IDs may be based on a desired number of concurrent invocations of a second function. For example, if four concurrent invocations of a second function are desired, then the range may be set to zero through two or one through three. The message group IDs are randomly assigned to messages by the first function such that each message can be routed to a concurrent invocation of the second function based on its message group ID.

In some aspects of the present disclosure, the number of concurrent invocations of the second function may be related to the maximum memory allocated to the second function. Rather than proceeding with a data transfer process, exceeding the maximum allocated memory, and having the process throttled or requesting more memory from the managed services provider, disclosed examples enable a system or user to configure, via a client device (e.g., the client device 104), the threshold number of invocations of the second function such that the maximum memory is not reached by any individual invocation while the second function is retrieving data from the storage service and writing that data to the cloud database.

The queue to which the first function passes the messages may be a queue handled by a cloud-based queueing service. In some examples, the queue may be a FIFO queue that can handle messages. The queueing service may receive the messages from the first function and may manage the message queue.

As described at block 308, an invocation of a second function (e.g., of a second computing service) may receive one or more messages form the queue. In some examples, the second function may be associated with a maximum number of routines that can write to the database. That is, for each invocation of the second function, a maximum number of routines may concurrently write data from the storage service to the database. The maximum number of routines may be set by a user via a client device (e.g., the client device 104). Thus, by configuring the number of concurrent routines, the system may relieve back pressure on the second function since configuration of the number of routines per invocation enables a user or system to widen or narrow the horizontal scaling of the data transfer process, regardless of whether the back pressure is loaded on the server of an internal service (e.g., the second computing service 116) or results from throttling write throughput in the database.

In some aspects of the present disclosure, a desired throughput of the system may equal n times m, where n is the number of second function invocations and m is the number of routines of each invocation of the second function allowed to simultaneously write to the database. Accordingly, the desired throughput of the system may be maintained, while varying concurrency of the invocations and routines of the second function. In some examples, the desired throughput may be based on a maximum capacity of the second function, throttling of maximum memory allocated to each function, or write capacity of the cloud-based database.

As described at block 310, the second function (e.g., second function of the second computing service 116), may retrieve data from the storage service based on the address information contained in each message received from the queue. For example, the second function may access data stored in a particular file of the storage service based on a pointer contained in a message.

As described at block 312, the second function writes the retrieved data to the database. For example, each invocation of the second function may include a number of routines based on the message group ID associated with the ingested data. For example, if an invocation of the second function receives a message containing data and the message is associated with a message group ID of m, then m routines of the invocation of the second function may simultaneously write to the database. Each routine may write to the database, thereby allowing control over write concurrency, which may be based, in part, on a write capacity of the database.

The above-described examples provide a number of improvements over current methods of large-scale data transfer. By using random number generation to assign message group IDs, invocations and routines of the second function may manage their own throttling and retrying such that the destination database may auto-scale its throughput. Conventional systems encounter setbacks in that they do not auto-scale throughput and therefore, conventional processes force failures while waiting for the destination database to scale resulting in lost time and money.

A further advantage of disclosed examples is that the systems and methods described are easily scalable. As an example, two data types may need to be transferred to two cloud databases. During the data transfer process, the generated notifications may be prefixed for each type of data. Thus, when the first function receives each notification, it can route the message to the appropriate queue based on the prefix, where there is a separate queue for each data type. In this example, each data type would have a second function reading from its respective queue and writing the data type to its respective database. Accordingly, for each data type being transferred to a separate database, an additional queue and second function can be added to handle each additional data type. In another scaling example, an additional queue between the storage service and the first function can be used to improve process speed.

Disclosed examples may also provide advantages in smaller-scale data transfer and in data transfer processes that run over extended periods of time. For example, disclosed processes reduce the risk of traffic spikes and gives a user or service subscribed greater control over how resources are used. This enables the service subscribed to manage costs associated with the data transfer process, and to avoid throttling or to avoid reaching write capacity.

The foregoing description of certain examples, including illustrated examples, has been presented only for purposes of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processor; and
a non-transitory computer-readable medium comprising instructions that are executable by the processor to cause the processor to:
receive, from a data warehouse, a data stream at a storage service;
receive, at a first function of a first computing service, one or more notifications, wherein each notification is generated when a file containing data from the data stream is created in the storage service;
in response to each notification, pass, by the first function, a message to a queue, the message comprising an address of a respective file within the storage service and a message group ID selected from a range;
receive, at an invocation of a second function at a second computing service, one or more messages from the queue, wherein the invocation of the second function to which each message is routed is based on the message group ID;
retrieve, by the second function, data from one or more files based on the address in each of the one or more messages; and
write, by the second function, the data to a database.

2. The system of claim 1, wherein the storage service comprises an event-driven object storage system.

3. The system of claim 2, wherein the first function is triggered to pass messages to the queue based on event data generated by the storage service, the event data comprising the notification.

4. The system of claim 1, wherein the storage service, the first computing service, the second computing service, and the database are hosted in a cloud-based system.

5. The system of claim 1, wherein the message group ID is randomly selected from the range.

6. The system of claim 1, wherein the queue is a first-in-first-out (FIFO) queue.

7. The system of claim 1, wherein a desired throughput can be adjusted by controlling a number of routines of each invocation of the second function that can simultaneously write to the database.

8. A method comprising:
receiving, from a data warehouse, a data stream at a storage service,
receiving, at a first function of a first computing service, one or more notifications, wherein each notification is generated when a file containing data from the data stream is created in the storage service;
in response to each notification, passing, by the first function, a message to a queue, the message comprising an address of a respective file within the storage service and a message group ID selected from a range;
receiving, at an invocation of a plurality of invocations of a second function at a second computing service, one or more messages from the queue, wherein the invocation of the second function to which each message is routed is based on the message group ID;
retrieving, by the second function, data from one or more files based on the address in each of the one or more messages; and
writing, by the second function, the data to a database.

9. The method of claim 8, wherein the storage service comprises an event-driven object storage system.

10. The method of claim 9, wherein the first function is triggered to pass messages to the queue based on event data generated by the storage service, the event data comprising the notification.

11. The method of claim 8, wherein the storage service, the first computing service, the second computing service, and the database are hosted in a cloud-based system.

12. The method of claim 8, wherein the message group ID is randomly selected from the range.

13. The method of claim 8, wherein the queue is a first-in-first-out (FIFO) queue.

14. The method of claim 8, wherein a desired throughput can be adjusted by controlling a number of routines of each invocation of the second function that can simultaneously write to the database.

15. A non-transitory computer-readable medium comprising instructions that are executable by a processor for causing the processor to:
receive, from a data warehouse, a data stream at a storage service;
receive, at a first function of a first computing service, one or more notifications, wherein each notification is generated when a file containing data from the data stream is created in the storage service;
in response to each notification, pass, by the first function, a message to a queue, the message comprising an address of a respective file within the storage service and a message group ID selected from a range;
receive, at an invocation of a plurality of invocations of a second function at a second computing service, one or more messages from the queue, wherein the invocation of the second function to which each message is routed is based on the message group ID;
retrieve, by the second function, data from one or more files based on the address in each of the one or more messages; and
write, by the second function, the data to a database.

16. The non-transitory computer-readable medium of claim 15, wherein the storage service comprises an event-driven object storage system.

17. The non-transitory computer-readable medium of claim 16, wherein the first function is triggered to pass messages to the queue based on event data generated by the storage service, the event data comprising the notification.

18. The non-transitory computer-readable medium of claim 15, wherein the storage service, the first computing service, the second computing service, and the database are hosted in a cloud-based system.

19. The non-transitory computer-readable medium of claim 15, wherein the message group ID is randomly selected from the range.

20. The non-transitory computer-readable medium of claim 15, wherein the queue is a first-in-first-out (FIFO) queue.
